(19) United States
(12) Patent Application Publication
(10) Pub. No.: US 2026/0131523 A1
(43) Pub. Date: May 14, 2026

(54) SHAPED STAINLESS STEEL BRAIDED POLYTETRAFLUOROETHYLENE (PTFE) TUBES AND SYSTEMS AND METHODS FOR FABRICATING THE SAME

(71) Applicant: Titeflex Commercial Inc., Springfield, MA (US)

(72) Inventors: Arif Mehmedovic, Hartford, CT (US); Gregory Rooke, Springfield, MA (US); Jet Liu, Jiangsu (CN); Noah Demers, Springfield, MA (US); Rick Martini, Southampton, MA (US)

(73) Assignee: Titeflex Commercial Inc., Springfield, MA (US)

(21) Appl. No.: 19/346,881

(22) Filed: Oct. 1, 2025

Related U.S. Application Data
(60) Provisional application No. 63/704,622, filed on Oct. 8, 2024.

(51) Int. Cl. B29C 53/08; B29C 53/84; B29K 27/18; B29K 305/12

(52) U.S. Cl. CPC B29C 53/083; B29C 53/84; B29K 2027/18; B29K 2305/12

(57) ABSTRACT

One aspect of the invention provides an apparatus including: a blank defining a path for receiving and holding a tube in a desired shape including at least one non-linear portion; a heater within or in thermal communication with the blank; and a controller programmed to control the heater to heat the blank and a tube received therein to a temperature sufficient to impart the desired shape upon the tube after cooling. Another aspect of the invention provides a tube including at least one non-linear portion produced according to any of the methods described herein.

### CROSS-REFERENCE TO RELATED APPLICATION

This application claims the benefit of priority to U.S. patent application Ser. No. 63/704,622, filed Oct. 8, 2024. The entire content of this application is hereby incorporated by referenced herein.

### FIELD

The present disclosure generally relates to the field of hose assemblies for transport of fluids. In particular, the present disclosure is related to stainless steel braided polytetrafluoroethylene (PTFE) tube.

### BACKGROUND

Tubing is used to transport variety of fluids in various applications. However, shaping hoses to specific shapes can be difficult and if manufactured poorly, can increase the potential for leaks. Manufacturing hoses with inadequate or manual shaping techniques can result in stress and damages to the hoses.

### SUMMARY OF THE INVENTION

One aspect of the invention provides an apparatus including: a blank defining a path for receiving and holding a tube in a desired shape including at least one non-linear portion; a heater within or in thermal communication with the blank; and a controller programmed to control the heater to heat the blank and a tube received therein to a temperature sufficient to impart the desired shape upon the tube after cooling.

This aspect of the invention can have a variety of embodiments. The blank can be a thermally conductive fixture. The blank can be an aluminum block.

The tube can be a PTFE-SS tube and the temperature can be between about 274° C. (about 525° F.) and about 288° C. (about 550° F.).

The controller can be further programmed to hold the tube at the temperature for a pre-defined duration. The duration can be selected from the group consisting of: between about 5 minutes and about 10 minutes, about 3 minutes, about 7 minutes, about 8 minutes, and about 9 minutes.

The controller can be further programmed to gradually cool the blank and the tube therein.

The apparatus can further include one or more temperature sensors. At least one of the one or more sensors can be integrated within the blank. The one or more temperature sensors can include one or more selected from the group consisting of: thermocouples, thermistors, and infrared sensors.

Another aspect of the invention provides a method for producing a tube including at least one non-linear portion. The method includes: providing a tube having a substantially linear profile at rest; placing the tube within a blank defining a path for receiving and holding the tube in a desired shape including at least one non-linear portion; heating at least the tube to a temperature sufficient to impart the desired shape upon the tube after cooling; cooling the tube; and removing the tube from the blank.

This aspect of the invention can have a variety of embodiments. The blank can be a thermally conductive fixture. The blank can be an aluminum block.

The tube can be a PTFE-SS tube and the temperature can be between about 274° C. (about 525° F.) and about 288° C. (about 550° F.).

A controller can be programmed to hold the tube at the temperature for a pre-defined duration. The duration can be selected from the group consisting of: between about 5 minutes and about 10 minutes, about 3 minutes, about 7 minutes, about 8 minutes, and about 9 minutes. The controller can be further programmed to gradually cool the blank and the tube therein.

One or more sensors can be integrated within the blank. The one or more sensors can include one or more selected from the group consisting of: thermocouples, thermistors, and infrared sensors.

Another aspect of the invention provides a tube including at least one non-linear portion produced according to any of the methods described herein.

### BRIEF DESCRIPTION OF THE DRAWINGS

FIG. 1A is a diagrammatic illustration of a hose assembly, according to one or more embodiments.

FIG. 1B is a diagrammatic illustration of a braided jacket for a hose assembly, according to one or more embodiments

FIG. 2 is a block diagram of an apparatus for producing a shaped stainless steel braided polytetrafluoroethylene tube, according to one or more embodiments.

FIG. 3 is an illustrative representation of a shaped hose assembly, according to one or more embodiments.

FIG. 4 is a flow diagram of a method for producing a stainless steel braided polytetrafluoroethylene tube, according to one or more embodiments.

### DETAILED DESCRIPTIONS

In some embodiments, the tube and manufacturing of the tube described herein addresses issues in the manufacturing of hoses, e.g. for automotive applications. For instance, the issues include difficulty in shaping hoses into precise configurations without compromising structural integrity, stress and potential damage caused by manual bending or inadequate shaping techniques, environmental and cost concerns associated with traditional methods using liquid PTFE and aramid yam. A standard straight hose, when bent, can naturally return to its original straight shape. In contrast, a pre-formed hose, when bent, can tend to revert to its pre-formed shape.

The process described herein can be used to form non-linear stainless steel braided hoses with internal PTFE liners. This process can allow for precise shaping of the hoses while maintaining the integrity and performance characteristics of the materials.

The process described herein can include the use of a thermally conductive fixture (e.g., aluminum) to hold the hose in the desired shape. A heater can be used to heat the hose and the fixture to between about 525° F. (˜273° C.) and about 550° F. (˜288° C.) for at least 9 minutes, ensuring uniform heating, e.g., with thermocouples. Gradual air cooling can be used to avoid thermal shock and maintain the bond between the PTFE liner and the braid. The process described herein can also include quality checks to verify shape conformity and Differential Scanning Calorimetry (DSC) tests. The stainless steel PTFE tubes produced herein can be used for automotive hoses and fittings, high-performance fluid transfer systems, and/or other applications requiring precise hose configurations with constrained spaces.

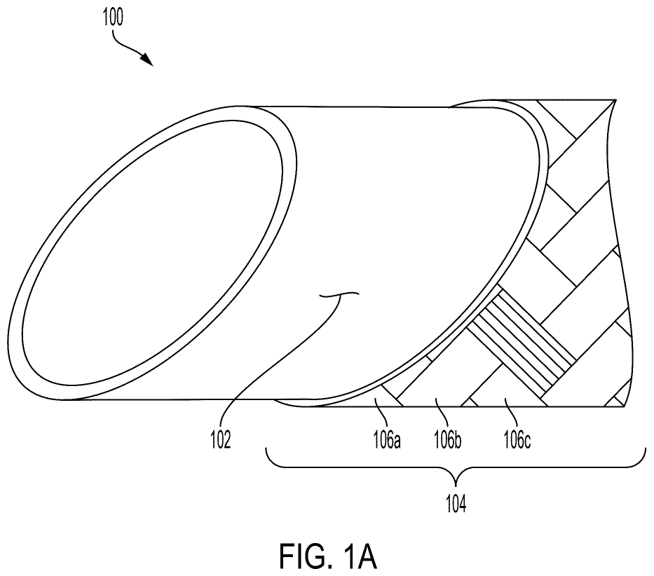

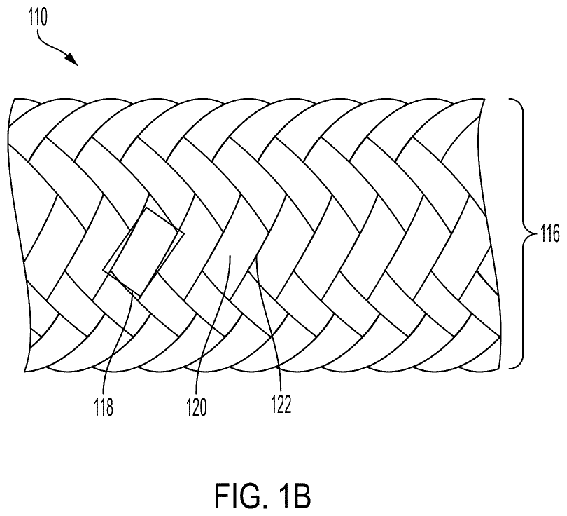

FIG. 1A is a diagrammatic illustration of a hose assembly 100, according to one or more embodiments. The hose assembly 100 includes an inner tube 102 and a jacket 104 circumferentially surrounding inner tube 102. The inner tube 102 can be composed of a polymer, for example, a fluoropolymer, such as, but not limited to, polytetrafluoroethylene (PTFE). In some implementations, the inner tube 102 can be completely or partially conductive. For example, an innermost section of the inner tube 102 (i.e., the inner surface adjacent to a longitudinal axis of inner tube 102) can be conductive. The thickness of this innermost section can be defined as a percentage of the entire thickness of inner tube 102 can, for example, an innermost 5%, 10%, 15%, 20%, 25%, and the like. The inner tube 102 or a section thereof can be rendered conductive by the incorporation of metal particles (e.g., copper, aluminum, gold, silver, nickel, and the like), carbon black, carbon fibers, or other conductive additives, and/or can be formed of a conductive material, such as a conductive elastomeric material. The inner tube 102 can be comprised of PTFE.

In some implementations, the jacket is formed by wrapping the plaits in a helical manner. Each plait 106 can have a substantially rectangular cross-section. That is, each plait 106 can have a width substantially greater than a height. In such an embodiment, the plaits 106 can be arranged in the braided jacket such that the wider side of the plaits 106 contacted the inner tube 102. Such an arrangement minimizes the thickness of the braided jacket 104 and provides more structural support to the inner tube 102. Each plait 106 can be formed from a plurality of individual strands of material. For example, each plait 106 can be formed from between 5 and 19 strands. In some implementations, each plait 106 can be or include a stainless-steel wire such that each stainless-steel wire is adjacent to each other to effectively form a ribbon shape.

FIG. 1B is a diagrammatic illustration of a braided jacket for the hose assembly 100 of FIG. 1A, according to one or more embodiments. FIG. 1B shows an exterior view of a tube 110 according to an embodiment of invention. The assembled tube 110 includes plaits 118, which are braided around an inner fluoropolymer tube (not shown). A portion 116 can be infused with a single type of resin. As previously described with respect to other figures, this portion could be arranged adjacent to various other portions infused with different resins. Some of those other portions can have different levels of rigidity or flexibility as desired to generate a flexibility profile across the length of the tubing.

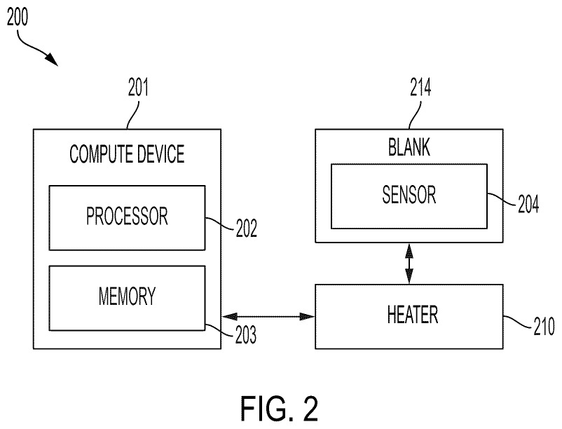

FIG. 2 is a block diagram of an apparatus 200 for producing a stainless steel braided PTFE tube, according to one or more embodiments. The apparatus 200 can include a blank 214, a heater 210, and a compute device 201. The blank 214 can define a path for receiving and holding a tube (e.g., PTFE tube) in a desired shape. For instance, the blank 214 can define a path to receive and hold at least one non-linear portion of the tube (not shown in FIG. 2). In some implementations, the blank 214 can be a thermally conductive fixture. In some implementations, the blank 214 can be an aluminum block with the non-linear path machined or cast. The heater 210 can be within the blank 214 or in thermal communication with the blank 214 to provide heat in the shaping of the tube. The tube can be a PTFE stainless steel (SS) tube and be heated by the heater 210 at a temperature between about 525° F. and about 550° F. The heater 210 can be communicatively coupled to the compute device 201.

The compute device 201 can include a processor 202 and a memory 203 that communicate with each other, and with other components, via a bus (not shown in FIG. 2). The bus can include any of several types of bus structures including, but not limited to, a memory bus, a memory controller, a peripheral bus, a local bus, and any combinations thereof, using any of a variety of bus architectures. The compute device 201 can be or include, for example, a computer workstation, a terminal computer, a server computer, and/or any machine capable of executing a sequence of instructions that specify an action to be taken by that machine, and any combinations thereof. The compute device 201 can also include multiple compute devices that can be used to implement a specially configured set of instructions for causing one or more of the compute devices to perform any one or more of the aspects and/or methodologies described herein.

The compute device 201 can include a network interface (not shown in FIG. 2) The network interface can be utilized for connecting the compute device 201 to one or more of a variety of networks and one or more remote devices connected thereto. The network can include, for example, private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WIMAX®), an optical fiber (or fiber optic)-based network, a BLUETOOTH® network, a virtual network, and/or any combination thereof. In some instances, the network can be a wireless network such as, for example, a Wi-Fi or wireless local area network (“WLAN”), a wireless wide area network (“WWAN”), and/or a cellular network. In other instances, the network can be a wired network such as, for example, an Ethernet network, a digital subscription line (“DSL”) network, a broadband network, and/or a fiber-optic network. In some instances, the compute device 201 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)).

The processor 202 can be or include, for example, a hardware based integrated circuit (IC), or any other suitable processing device configured to run and/or execute a set of instructions or code. For example, the processor 202 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 202 can be configured to run any of the methods and/or portions of methods discussed herein.

The memory 203 can be or include, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor 202 to perform one or more processes, functions, and/or the like. In some implementations, the memory 203 can include extendable storage units that can be added and used incrementally. In some implementations, the memory 203 can be a portable memory (e.g., a flash drive, a portable hard disk, and/or the like) that can be operatively coupled to the processor 202. In some instances, the memory 203 can be remotely operatively coupled with a compute device (not shown); for example, a remote database device can serve as a memory and be operatively coupled to the compute device. The memory 203 can include various components (e.g., machine-readable media) including, but not limited to, a random-access memory component, a read only component, and any combinations thereof. In one example, a basic input/output system (BIOS), including basic routines that help to transfer information between components within the compute device 201, such as during start-up, can be stored in memory 203. The memory 203 can further include any number of program modules including, for example, an operating system, one or more application programs, other program modules, program data, and any combinations thereof.

The sensor 204 can be or include, for example, one or more temperature sensors. For instance. In some implementations, the one or more temperature sensors can include one or more selected from the group consisting of: thermocouples, thermistors, and infrared sensors. In some implementations, the sensor 204 can be integrated within the blank 214.

The compute device 201 can be programmed to control the heater 210 based on instructions stored in the memory 203 and executed by the processor 202. The memory 203 can include instructions to cause the processor 202 to control the heater 210 to heat the blank 214 and the tube to a temperature sufficient to impart the desired shape upon the tube after cooling. The memory 203 can include instructions to cause the processor 202 to maintain the temperature for the tube for a pre-determined duration. For example, the duration can be selected from the group consisting of: between about 5 minutes and about 10 minutes, about 2 minutes, about 7 minutes, about 8 minutes, and about 9 minutes. In some implementations, the memory 203 can include instructions to further cause the processor 203 to gradually cool the blank 214 and the tube therein.

Temperature measurement sensors may be positioned at various points of the system (e.g. within or adjacent to blank 214) to measure operating temperatures. Measured temperatures may be used by the compute device 201 or merely for reference. Exemplary temperature sensors include thermocouples, thermistors, infrared sensors, and the like.

Principles of how to use feedback (e.g., from a temperature sensor such as thermocouple, a thermistor, infrared and the like) in order to modulate operation of a component are described, for example, in Karl Johan Astrom & Richard M. Murray, Feedback Systems: An Introduction for Scientists & Engineers (2008) and can be implemented using a Proportional-Integral-Derivative (PID) controller and the like.

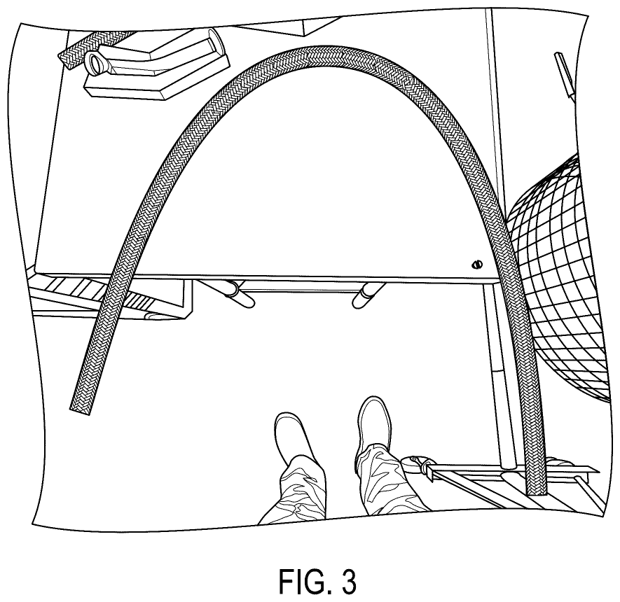

FIG. 3 is an illustrative representation of a shaped hose assembly, according to one or more embodiments. As shown in FIG. 3, the hose assembly can be flexibly shaped and manufactured with an outer layer including a braided jacket.

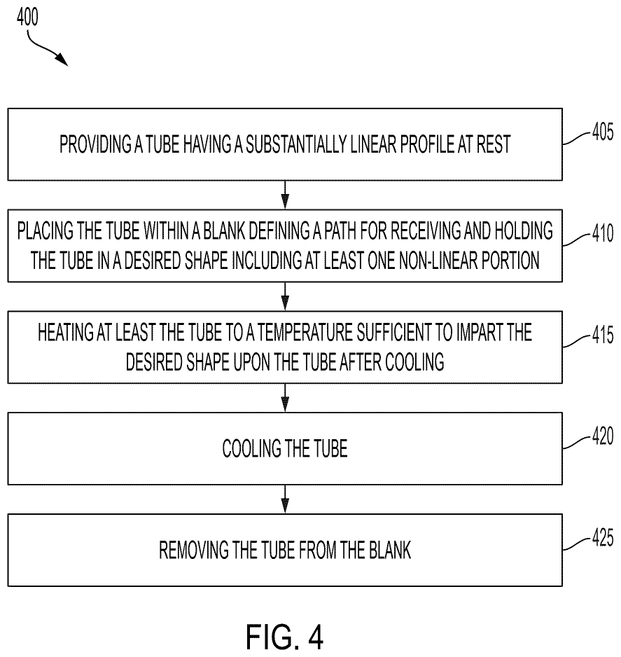

FIG. 4 is a flow diagram of a method 400 for producing a stainless steel braided polytetrafluoroethylene tube, according to one or more embodiments. At 405, the method 400 includes providing a tube having a substantially linear profile at rest, which can include residual curvature imparted by previous storage on a reel. At 410, the method 410, the method 400 includes placing the tube within a blank defining a path for receiving and holding a tube in a desired shape including at least one non-linear portion. At 415, the method 400 includes heating at least the tube to a temperature sufficient to impart the desired shape upon the tube after cooling. At 420, the method 400 includes cooling the tube. At 425, the method 400 includes removing the tube from the blank.

In some implementations, the blank can be thermally conductive fixture and/or an aluminum block. The tube provided can be a PTFE-SS tube. The method 400 can include maintaining, via a controller, the temperature to heat the tube for a pre-defined duration and/or between 525° F. and about 550° F. For instance, the method 400 can include heating the tube and/or holding the temperature for between about 5 minutes and about 10 minutes, about 2 minutes, about 7 minutes, about 8 minutes, and about 9 minutes. In some implementations, the method 400 can include gradually cooling the blank and tube via the controller. In some implementations, the blank can be integrated with one or more sensors such as, for example, thermocouples, thermistors, and infrared sensors. The tube that is produced can have at least one non-linear portion. The tube can have an inner layer of PTFE and an outer jacket surrounding the inner layer that includes interwoven plaits that consist of a plurality of stainless-steel wires lying adjacent to each other to effectively form a ribbon.

It is to be noted that any one or more of the aspects and embodiments described herein can be implemented using one or more machines programmed according to the teachings of the present specification. Appropriate software coding can be prepared by skilled programmers based on the teachings of the present disclosure. Aspects and implementations discussed above employing software and/or software modules can also include appropriate hardware for assisting in the implementation of the machine executable instructions of the software and/or software module.

Such software can be a computer program product that employs a machine-readable storage medium. A machine-readable storage medium can be any medium that is capable of storing and/or encoding a sequence of instructions for execution by a machine (e.g., a compute device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software can also include information (e.g., data) carried as a data signal on a data carrier, such as a carrier wave. For example, machine-executable information can be included as a data-carrying signal embodied in a data carrier in which the signal encodes a sequence of instruction, or portion thereof, for execution by a machine (e.g., a compute device) and any related information (e.g., data structures and data) that causes the machine to perform any one of the methodologies and/or embodiments described herein.

Examples of a compute device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a compute device can include and/or be included in a kiosk.

All combinations of the foregoing concepts and additional concepts discussed herewithin (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program may be built up or into which a complex activity may be analyzed. A module can also be an extension to a main program dedicated to a specific function. A module can also be code that is added in as a whole or is designed for easy reusability.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 3%, 5%, 4%, 3%, 2%, 1%, 0.5%, 0.1%, 0.05%, or 0.01% of the stated value. Unless otherwise clear from context, all numerical values provided herein are modified by the term about.

Unless specifically stated or obvious from context, the term “or,” as used herein, is understood to be inclusive.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., the anatomical context in which proximal and distal use the patient as reference, or where the entry point is distal from the user.

Ranges provided herein are understood to be shorthand for all of the values within the range. For example, a range of 1 to 50 is understood to include any number, combination of numbers, or sub-range from the group consisting 1, 2, 3, 4, 5, 3, 7, 8, 9, 10, 11, 12, 13, 14, 15,16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus comprising:
a blank defining a path for receiving and holding a tube in a desired shape including at least one non-linear portion;
a heater within or in thermal communication with the blank; and
a controller programmed to control the heater to heat the blank and a tube received therein to a temperature sufficient to impart the desired shape upon the tube after cooling.

2. The apparatus of claim 1, wherein the blank is a thermally conductive fixture 3. The apparatus of claim 1, wherein the blank is an aluminum block.

4. The apparatus of claim 1, wherein:
the tube is a PTFE-SS tube; and
the temperature is between about 274° C. (about 525° F.) and about 288° C. (about 550° F.).

5. The apparatus of claim 1, wherein the controller is further programmed to hold the tube at the temperature for a pre-defined duration.

6. The apparatus of claim 5, wherein the duration is selected from the group consisting of:
between about 5 minutes and about 10 minutes, about 3 minutes, about 7 minutes, about 8 minutes, and about 9 minutes.

7. The apparatus of claim 1, wherein the controller is further programmed to gradually cool the blank and the tube therein.

8. The apparatus of claim 1, further comprising one or more temperature sensors.

9. The apparatus of claim 8, wherein at least one of the one or more temperature sensors is integrated within the blank.

10. The apparatus of claim 8, wherein the one or more temperature sensors include one or more selected from the group consisting of: thermocouples, thermistors, and infrared sensors.

11. A method for producing a tube including at least one non-linear portion, the method comprising:
providing a tube having a substantially linear profile at rest;
placing the tube within a blank defining a path for receiving and holding the tube in a desired shape including at least one non-linear portion;
heating at least the tube to a temperature sufficient to impart the desired shape upon the tube after cooling;
cooling the tube; and
removing the tube from the blank.

12. The method of claim 11, wherein the blank is a thermally conductive fixture.

13. The method of claim 11, wherein the blank is an aluminum block.

14. The method of claim 11, wherein:
the tube is a PTFE-SS tube; and
the temperature is between about 274° C. (about 525° F.) and about 288° C. (about 550° F.).

15. The method of claim 11, wherein a controller is programmed to hold the tube at the temperature for a pre-defined duration.

16. The method of claim 15, wherein the duration is selected from the group consisting of:
between about 5 minutes and about 10 minutes, about 3 minutes, about 7 minutes, about 8 minutes, and about 9 minutes.

17. The method of claim 15, wherein the controller is further programmed to gradually cool the blank and the tube therein.

18. The method of claim 11, wherein one or more sensors is integrated within the blank.

19. The method of claim 18, wherein the one or more sensors include one or more selected from the group consisting of: thermocouples, thermistors, and infrared sensors.

20. A tube including at least one non-linear portion produced according to the method of claim 11.
